(19) United States
(12) Patent Application Publication
(10) Pub. No.: US 2011/0158560 A1
(43) Pub. Date: Jun. 30, 2011

(54) INTERNAL STRAP HANDLE BAG

(75) Inventors: Lawrence B. Nicolais, Elkins Park, PA (US); Michael L. Abell, Bowling Green, KY (US)

(73) Assignee: SCA HYGIENE PRODUCTS AB, Goteborg (SE)

(21) Appl. No.: 12/648,367

(22) Filed: Dec. 29, 2009

(51) Int. Cl. B65D 33/06; B65D 30/20; B31B 1/25; B31B 1/86; B31B 1/64; B31B 1/26; B31B 1/00

(52) U.S. Cl. 383/21; 383/120; 493/240; 493/226; 493/189; 493/243; 493/267

(57) ABSTRACT

A bottom gusset bag includes a bottom gusset connecting a front and rear panel. The side regions of the front and rear panels are sealed to each other in a pair of side seams in a manner such that when the bag is unfilled it is flattened and when the bag is filled it is substantially a six-sided cubic shape with the bottom of the filled bag formed of the bottom gusset being substantially flat. The bottom gusset bag further includes a handle that includes a strip of material interior of the bottom gusset with the ends of the handle joined to each pair of side seams. Further, the bottom gusset bag can include weakened portions in the bottom gusset on opposing sides of the handle that, when broken, expose holes for a hand or fingers to enter the bottom gusset and wrap around the internal handle for carrying the bottom gusset bag with the bottom facing upwards.

### FIELD OF THE INVENTION

The present disclosure relates to an internal handle for a gusset bag. More particularly, the present disclosure relates to a gusset bag having a strap handle along the inner surface of the gusset accessible by pushing a hand or fingers through holes in the gusset panel.

### BACKGROUND OF THE INVENTION

Bottom gusset bags are typically used to contain goods, where the goods act as the support to hold the bags in a particular shape. For convenience of transporting the filled bottom gusset bags, handles have been added to the bags. When filled with product and sealed, the bottom gusset is used as the bags upward facing surface because it is usually more aesthetically pleasing. This also provides a place to add handles that do not interfere with the loading and final sealing of a bag at the open end of the bag. Completed, sealed bags are generally “cubic” or hexahedral in configuration when filled with goods such as disposable diapers or adult disposable briefs.

There are several ways to make external handles or to attach a handle to a preformed plastic gusseted bag. Some of the methods add significant cost to the bag because a relatively large amount of plastic film is added to the bag forming a handle. These methods generally make strong handles that function well, but are costly.

Some methods keep material costs low by forming a handle from part of the existing bag without adding extra material. However, these handles can be weak and may not be suitable for heavier or larger bags.

Another method is the attachment of a plastic film strap to the surface that is upward facing when the bag is carried. This bag style is commonly called a bottom gusset strap handle bag or bottom gusset bag with strap handle. When filled with product and sealed, the bag may be turned upside down, presenting the bottom panel as the top containing the strap for carrying. This method is typically a compromise in material cost and strength between the previously mentioned ideas. Although the strap can be designed to function well as a handle for various weights and sizes of bags, the strap is not aesthetically pleasing. Specifically, the strap is typically loose on the gusset panel of the filled bag, which is exposed during display at retail outlets.

Further, the exterior plastic film strap has a negative impact on the automated packaging process because the strap can become entangled in the packaging machinery. An entangled exterior plastic film strap can lead to the destruction of the handle or bag, or can jam the conveyor system leading to downtime in the automatic packing process. Further, strap handle bags are typically shipped in shipping boxes, and an exterior plastic film strap can interfere with packing the bags into the shipping box or get caught in the taped or glued seal of the shipping box, rendering the handle or bag damaged or useless when the box is opened and bags withdrawn.

Accordingly, there is a need in the art for a bottom gusset bag with handle that is easy to manufacture using existing bag making machines, inexpensive, effective and easy to use by the consumer, aesthetically pleasing to display, and does not cause packaging line problems.

### SUMMARY

According to a first aspect of the invention, a bottom gusset bag includes a bottom gusset connecting a front panel having an upper edge, lower edge, and two side regions and a rear panel having an upper edge, lower edge, and two side regions. The bottom gusset joins the front and rear panels at the lower edges. The side regions of the front and rear panels are sealed to each other in a pair of side seams in a manner such that when the bag is unfilled it is flattened and when the bag is filled it is substantially a six-sided cubic shape with front, rear, top, bottom, and two side walls. The bottom is formed of the bottom gusset being substantially flat. The bag further includes a handle including a strip of material interior of the bottom gusset. A first end of the strip is joined to a first pair of side regions at the side seam of the front and rear panels and a second end of the strip is joined to a second pair of side regions at the side seam of the front and rear panels.

According to a second aspect of the invention, a method of manufacturing a bag includes folding a material laterally on itself to form front and rear panels and a gusset between the front and rear panels at the bottom of the bag. Sealing the side regions of the front and rear panels to form side seams. Sealing a handle to the side seams such that the handle extends along an inner surface of the gusset and each end is joined directly to the side regions of the front and rear panels at a side seam.

According to a third aspect, a bottom gusset material to be formed into a bottom gusset bag includes a material folded laterally on itself to form front and rear panels and a gusset between the front and rear panels. The material further includes a handle that includes a strip of material positioned interior of the gusset. The strip of material is centered along a central fold line forming the upper extent of the gusset and extends substantially the length of the gusset. The gusset material further includes weakened portions in the gusset on opposing sides of the handle, wherein the weakened portions can be broken to expose at least two holes in the gusset material, with at least one hole on each side of the handle.

A further feature of the first and second aspects is that the bag further includes weakened portions of the material in the bottom gusset on opposing sides of the handle, wherein the weakened portions can be broken to expose at least two holes in the bottom gusset, with at least one hole on each side of the handle.

Yet a further feature of the first, second, and third aspects is that the weakened portions include perforation.

Still yet a further feature of the first and second aspects is that the an end of the handle is joined to the side seams as close as possible to the point at which the bottom gusset is joined to the side seam and within the region of the side seam that includes the bottom gusset.

Still yet a further feature of the first and third aspects is that the bag and handle are formed of heat sealable plastic films or heat sealable non-woven materials.

Still yet a further feature of the first and third aspects is that the handle and the material forming the bag are formed of different materials.

Still yet a further feature of the first and third aspects is that the handle and the material forming the bag are formed of the same materials.

Still yet a further feature of the second aspect is that the handle is sealed to the ends of the bottom gusset panel prior to the side region sealing step.

Yet still another feature of the second aspect is that the handle is sealed to the ends of the bottom gusset panel during the side region sealing step.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements.

FIG. 1 shows a perspective view of an exemplary embodiment of a bottom gusset bag having an internal strap handle.

FIG. 2 is a cross sectional view of the bottom of the gusset bag taken along line II-II of FIG. 1.

FIG. 3 is a partial exploded view of a corner of the gusset bag of FIG. 1

FIG. 4 is a partial perspective view of an exemplary bottom gusset material prior to being formed into a bottom gusset bag.

FIG. 5 is a partial exploded view of a corner of an exemplary bottom gusset bag.

FIG. 6 is a partial perspective view of another exemplary bottom gusset material prior to being formed into a bottom gusset bag.

### DETAILED DESCRIPTION OF THE PREFERRED EMBODIMENTS

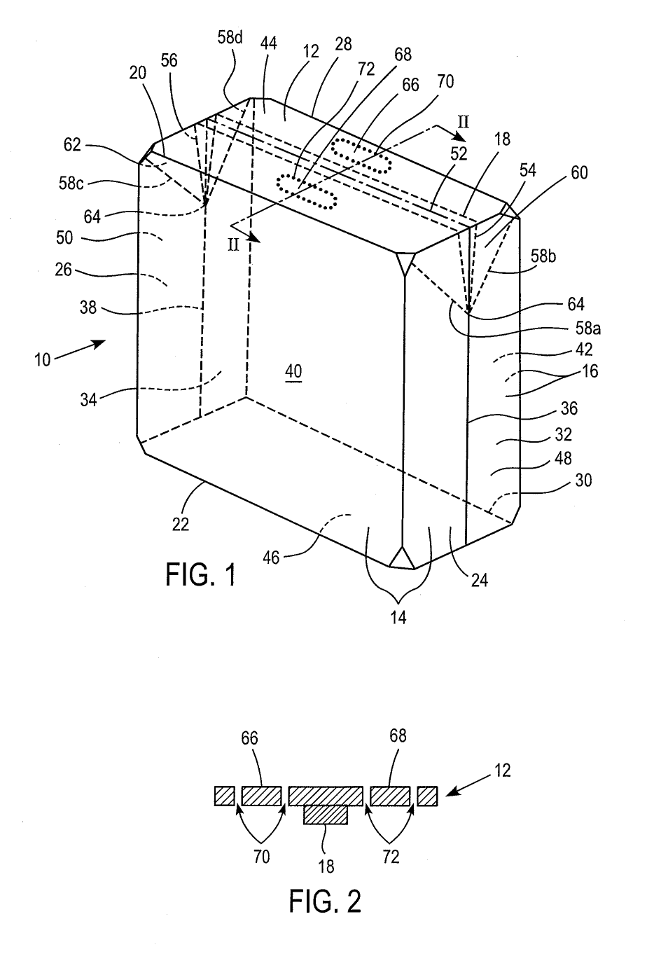

With reference to FIGS. 1-3, a first embodiment of a gusset bag in accordance with the present invention is described in more detail. A bottom gusset bag can be made of a material that is folded and sealed to form a bag that is flattened when unfilled and maintains a particular shape based on the goods contained when the bag is filled. Goods stored in gusset bags can include infant diapers and training pants and adult incontinence products. However, the bottom gusset bags can be used to store other types of goods. While FIGS. 1-3 specifically illustrate a filled gusset bag 10 having a generally “cubic” or hexahedral configuration, the gusset bag may form different shapes depending on the type of goods to be contained.

With reference in particular to FIG. 1, a gusset bag 10 includes a bottom gusset 12 connecting a front panel 14 and a rear panel 16. The front panel 14 includes a front lower edge 20, front upper edge 22, and two front side regions 24, 26. The rear panel 16 includes a rear lower edge 28, rear upper edge 30, and two rear side regions 32, 34. The bottom gusset 12 joins the front and rear panels 14, 16 at respective lower edges 20, 28. The first front side region 24 is joined to a first rear side region 32 at a first side seam 36. The second front side region 26 is joined to a second rear side region 34 at a second side seam 38.

When the bottom gusset bag 10 is unfilled, it is flattened. When the bottom gusset bag 10 is filled with goods as it is shown in FIG. 1, the bag assumes a substantially six-sided cubic shape with front 40, rear 42, bottom 44, top 46, and two side walls 48, 50. The bottom 44, which in use is the upward surface of the filled bag, is formed of the bottom gusset 12 in a substantially flat state.

The bottom gusset bag 10 further includes an internal handle 18. In a first embodiment, the handle is a strip of material interior of the bottom gusset. With reference in particular to FIG. 1, the handle 18 extends along the central fold line 52 of the inner surface of the bottom gusset 12. Further the handle 18 extends substantially the length of the bottom gusset 12. The first end 54 of the handle is joined directly to first front side region 24 and first rear side region 32 at the side seam 36. The second end 56 of the handle is joined directly to second front side region 26 and second rear side region 34 at the side seam 38. With reference to FIG. 1, first and second ends 54, 56 of the handle are joined to first and second side seams 36, 38, respectively.

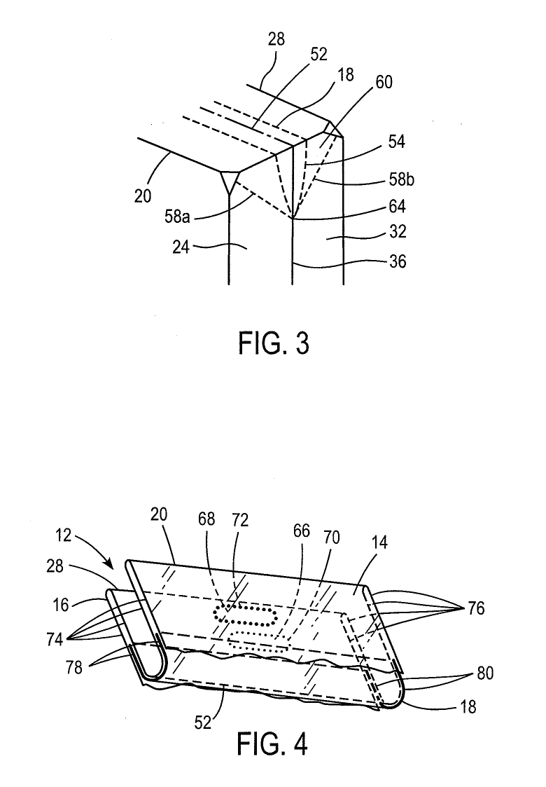

With reference to FIGS. 1 and 3, the bottom gusset bag 10 further includes angle folds 58. In FIGS. 1 and 3, first angle fold 58a joins the front side of the first end 60 of the bottom gusset to the first front side region 24, and second angle fold 58b joins the rear side of the first end 60 of the bottom gusset to the first rear side region 32. The first and second angle folds 58a, 58b each extend from respective upper edges 20, 28 of the front and rear panels to a common point 64 at the first side seam 36. In the same manner, the third angle fold 58c and fourth angle fold 58d join the front side of the second end 62 of the bottom gusset to the second front side region 26 and the rear side of the second end 62 of the bottom gusset to the second rear side region 34, respectively. When the bag is filled, the ends 60, 62 of the bottom gusset form a portion of the side walls 48, 50.

With reference to FIG. 1, each end 54, 56 of the handle are joined to respective side regions at the common point 64. As further illustrated in FIG. 3, an end 54 of the handle is embedded into the side seal adjacent to point 64 such that the edge of the handle is at or as close as possible to common point 64 at which the bottom gusset 12 is joined to the side seam 36 and within the region of the side seam that includes the bottom gusset.

FIG. 4 shows an exemplary gusset material prior to forming a bottom gusset bag by sealing the edges to form closed sides. The bottom gusset 12 is folded inward with a fold line 52 forming the upper extent of the bottom gusset 12 during its flattened state. FIG. 4 shows the internal handle 18 wrapped around the upper portion of the bottom gusset 12. The lower extent of the bottom gusset when it is flattened is at lower edges 20, 28. Lower edges 20 and 28 delimit the connection of the bottom gusset 12 to the front panel 14 and rear panel 16, respectively. The edge 74 of the bottom gusset 12, front panel 14, and rear panel 16 can be sealed to form a second side seam when forming a bottom gusset bag, as illustrated in FIG. 1. Additionally, the edge 76 of the bottom gusset 12, front panel 14, and rear panel 16 can be sealed to form a first side seam when forming a bottom gusset bag, as illustrated in FIG. 1. Further a handle edge 78 is joined to edge 74, and a handle edge 80 is joined to edge 76. The handle edges can be joined to the corresponding edges prior to or during the step of sealing the edges to form a side seam.

FIG. 6 shows another exemplary gusset material similar to the gusset material of FIG. 4 except the internal handle 18 is positioned differently. The bottom gusset 12 is folded inward with a fold line 52 foaming the upper extent of the bottom gusset 12 during its flattened state. In the embodiment of FIG. 6, the internal handle is positioned adjacent to or very close to one side of the fold line 52. The lower extent of the bottom gusset when it is flattened is at lower edges 20, 28. Lower edges 20 and 28 delimit the connection of the bottom gusset 12 to the front panel 14 and rear panel 16, respectively. The edge 74 of the bottom gusset 12, front panel 14, and rear panel 16 are sealed to form a second side seam when forming a bottom gusset bag, as illustrated in FIG. 1. Additionally, the edge 76 of the bottom gusset 12, front panel 14, and rear panel 16 are sealed to form a first side seam when forming a bottom gusset bag, as illustrated in FIG. 1. Further a handle edge 78 is joined to edge 74, and a handle edge 80 is joined to edge 76. The handle edges can be joined to the corresponding edges prior to or during the step of sealing the edges to form a side seam. When a bottom gusset bag formed from the exemplary gusset material of FIG. 6 is filled, the internal handle 18 will center itself along the fold line 52, as shown in FIG. 1, when the internal handle is sealed at or near the common point 64.

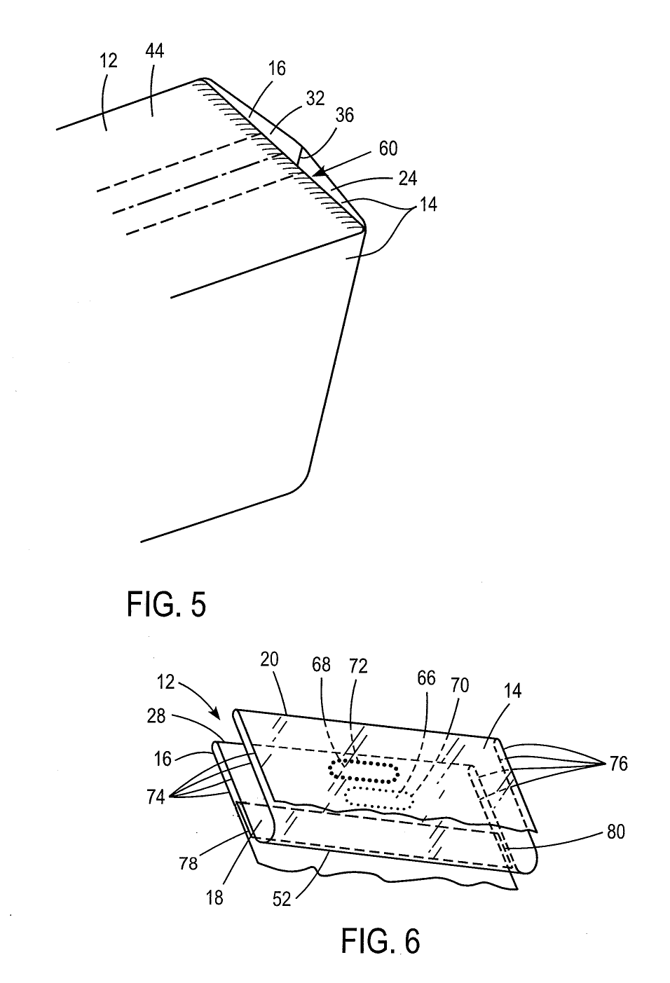

FIG. 5 shows an exploded view of a bottom corner of a bottom gusset bag. FIG. 5 illustrates that in a filled state, the side regions 24, 32 of front panel 14 and rear panel 16, respectively, can be a distance away from the bottom 44 formed of the bottom gusset 12. This distance is due to the fact that the side wall of the bottom gusset bag is formed by sealing only the edges at the side seam 36. Because of the single seal at the side seam 36, the end of the bottom gusset 60 that forms a portion of the side wall of the bottom gusset bag in its filled state is folded up into the gap formed by the distance between the bottom 44 and the side regions 24, 32.

In certain embodiments, the bag and handle are formed of flaccid material. A flaccid material is defined as a material that is flexible and used to cover articles that will act as a support for the material. In more certain embodiments, the bag and handle are formed of plastic films or non-woven materials. In yet more certain embodiments, plastic films and non-woven are heat sealable so that any or all of the side seams, angle seals, or connection of the handle to the interior of the bag are formed by heat sealing. Exemplary heat sealable materials that can be used are plastic films or non-woven materials including, for example, polyethylene, polypropylene or polylactic acid. Polylactic acid has the additional advantage of being biodegradable. The bag and handle can be made from the same or different materials. Differences in materials forming the bag and handle can include, for example, differences in type of plastic, color, weight, or strength.

In further embodiments, the gusset includes weakened portions in the bottom gusset on opposing sides of the handle. In particular reference to FIGS. 1-2, 4 and 6, the bottom gusset 12 includes two weakened portions 70, 72 on opposing sides of the handle 18, where the weakened portions 70, 72 can be broken to expose holes 66, 68 on either side of the handle. FIGS. 1-2, 4, and 6 illustrate weakened portions 70, 72 that completely surround holes 66, 68, and are comprised of perforations to enable a user to insert a hand or fingers into the bottom gusset material in the portions delimited by the weakened portions 70, 72. The holes can be exposed by a portion of the weakened portions 70, 72 being broken such that a flap is formed that allows access of a hand or fingers to wrap around the internal handle 18. In other embodiments, the material within the weakened portions 70, 72 can be partially or completely removed. In other embodiments, the weakened portions of the bottom gusset only partially surround material in which holes will be exposed. To expose the holes, the weakened portions are broken and the material is folded away from the exposed hole along the non-weakened portion surrounding the material. Further, it should be understood that the weakened portion can include any known method of weakening the bottom gusset material, and is not limited to perforations.

Further in reference to FIGS. 1, 4 and 6, the weakened portions 70, 72 have an oblong shape. The oblong shape can be useful for holes in which a hand will be inserted. Exemplary oblong shaped holes include holes with a width that is at least about half the length. In particular embodiments, holes are exposed when the weakened portions are broken by entry of a hand or fingers that can close around the internal handle when transporting the gusset bag. In more particular embodiments, the holes can be of sufficient size to enable entry of a thumb in one hole and the remaining fingers on the same hand in a hole on the other side of the handle. In the embodiment illustrated in FIGS. 1, 4 and 6, the holes are the same size so that either hole can accommodate the fingers of a hand while the other hole accommodates a thumb. In other embodiments, the holes can be shaped or sized for other accommodations. For example, one hole acting as a thumb hole can be formed substantially smaller than the other hole. In certain embodiments, each hole may have a width that is less than about one quarter of the width of the bottom gusset.

In certain embodiments, the handle has a width that is substantially smaller than the width of the bottom gusset. The width of the handle is especially smaller when weakened portions for forming holes are incorporated in the bottom gusset on either side of the handle. In some embodiments, the width of the handle is less than about a third the width of the bottom gusset. In further embodiments, the width of the handle is less than about a quarter the width of the bottom gusset. In yet further embodiments, the width of the handle is less than about a sixth the width of the bottom gusset. In more certain embodiments, the handle and each hole to be exposed in the bottom gusset may have substantially the same width, while in other embodiments, each may have a distinct width.

An embodiment of a method of making the above described bottom gusset bag includes folding and sealing a material into a bottom gusset bag. In particular embodiments, the material is folded laterally on itself to form front and rear panels and a bottom gusset panel between the front and rear panels at the bottom of the bag. Side regions of the front and rear panels are sealed to form side seams to close the sides of the bottom gusset bag. A handle in the form of a strip of material is extended substantially the length of the inner surface of the bottom gusset along the central fold line. Each end of the handle is joined directly to an inner surface of the side regions of the front and rear panels at the edge where the side seam is formed when joining the side regions to each other. In many embodiments, the step of sealing the ends of the handle to an inner surface of the bag, sealing the front and rear panels at respective side seams, and sealing a bottom gusset to the front and back panels is each accomplished by heat sealing. The handle can be sealed to the ends of the bottom gusset panel prior to the side region sealing step, or simultaneously with the side region sealing steps.

In particular embodiments, the method further includes the step of weakening a portion of the material forming the bottom gusset on opposing sides of the handle where the weakened portions can be broken to expose at least two holes in the bottom gusset, with at least one hole on each side of the handle. The material can be weakened by any known method for creating weakened material that can be easily torn. In a more particular embodiment, the weakening step includes punching small holes in the bottom gusset material to form perforations. The weakening step can be performed to create any shape or size for completely removing or partially removing material for exposing holes described above.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. A gusset bag comprising:
a bottom gusset connecting a front panel having an upper edge, lower edge, and two side regions and a rear panel having an upper edge, lower edge, and two side regions, the bottom gusset joins the front and rear panels at the lower edges, the side regions of the front and rear panels are sealed to each other in a pair of side seams in a manner such that when the bag is unfilled it is flattened and when the bag is filled it is substantially a six-sided cubic shape with front, rear, top, bottom, and two side walls, wherein the bottom is formed of the bottom gusset being substantially flat, and a handle comprising a strip of material interior of the bottom gusset with a first end of the strip joined to a first pair of side regions at a first side seam of the front and rear panels and a second end of the strip joined to a second pair of side regions at a second side seam of the front and rear panels.

2. The bag of claim 1 further comprising weakened portions of the material in the bottom gusset on opposing sides of the handle, wherein the weakened portions can be broken to expose at least two holes in the bottom gusset, with at least one hole on each side of the handle.

3. The bag of claim 2, wherein the weakened portions comprise perforations.

4. The bag of claim 1, wherein an end of the handle is joined to the side seams as close as possible to the point at which the bottom gusset is joined to the side seam and within the region of the side seam that includes the bottom gusset.

5. The bag of claim 1, wherein the bag and handle are formed of heat sealable plastic films or heat sealable non-woven materials.

6. The bag of claim 1, wherein the handle and the material forming the bag are formed of different materials.

7. The bag of claim 1, wherein the handle and the material forming the bag are formed of the same materials.

8. A method of manufacturing a bag, comprising:
folding a material laterally on itself to form front and rear panels and a gusset panel between the front and rear panels at the bottom of the bag;
sealing side regions of the front and rear panels to form side seams; and
sealing a handle to the side seams,
wherein the handle extends along an inner surface of the bottom gusset and each end of the handle is joined directly to the side regions of the front and rear panels at a side seam.

9. The method of claim 8 further comprises the step of weakening a portion of the material forming the bottom gusset on opposing sides of the handle, wherein the weakened portions can be broken to expose at least two holes in the bottom gusset, with at least one hole on each side of the handle.

10. The method of claim 9, wherein the weakening step includes forming perforation.

11. The method of claim 8, wherein an end of the handle is joined to the side seams as close as possible to the point at which the bottom gusset is joined to the side seam and within the region of the side seam that includes the bottom gusset.

12. The method of claim 8, wherein the handle is sealed to the ends of the bottom gusset panel prior to the side region sealing step.

13. The method of claim 8, wherein the handle is sealed to the ends of the bottom gusset panel during the side region sealing step.

14. A bottom gusset material to be formed into a bottom gusset bag comprising a material folded laterally on itself to form front and rear panels and a gusset between the front and rear panels, a handle comprising a strip of material positioned interior of the gusset, wherein the strip of material is centered along a central fold line forming the upper extent of the gusset and extends substantially the length of the gusset, and wherein the gusset material further comprises weakened portions in the gusset on opposing sides of the handle, wherein the weakened portions can be broken to expose at least two holes in the gusset material, with at least one hole on each side of the handle.

15. The bottom gusset material of claim 14, wherein the weakened portions comprise perforation.

16. The bottom gusset material of claim 14, wherein the bag and handle are formed of heat sealable plastic films or heat sealable non-woven materials.

17. The bottom gusset material of claim 14, wherein the handle and the material forming the bag are formed of different materials.

18. The bottom gusset material of claim 14, wherein the handle and the material forming the bag are formed of the same materials.
